(19) United States
(12) Patent Application Publication
(10) Pub. No.: US 2020/0159860 A1
(43) Pub. Date: May 21, 2020

(54) SEARCH ENGINE USER INTERFACE AI SKINNING

(71) Applicant: MICROSOFT TECHNOLOGY LICENSING, LLC, Redmond, WA (US)

(72) Inventors: Liang DU, Redmond, WA (US); Ranjith NARAYANAN, Bellevue, WA (US); Robin ABRAHAM, Redmond, WA (US); Vijay MITAL, Kirkland, WA (US)

(21) Appl. No.: 16/192,688

(22) Filed: Nov. 15, 2018

(51) Int. Cl. G06F 17/30; G06N 5/00

(52) U.S. Cl. CPC G06F 17/30867; G06N 5/003; G06F 17/30991; G06F 17/30616

(57) ABSTRACT

Applying AI models to a search using a search engine for a user. A method includes receiving user search input at a search engine user interface. The search input is used with the search engine to obtain first search results. One or more AI models are applied to the first search results to obtain additional search data. The additional search data is searched to identify additional search results. Using the additional search results, a subset of second search results are identified from the first search results while filtering out other search results from the first search results. At least a portion of the second search results are provided to the user in the user interface while preventing the other search results that were filtered from being displayed in the user interface, such that a user at the user interface has the second search results returned as results.

### BACKGROUND

### Background and Relevant Art

The use of search engines in modern times is ubiquitous. Search engines allow users to find pieces of information from wide-ranging topics and sources. Indeed, modern search engine technology gives users access to an almost unlimited amount of data. However, there are drawbacks to having a nearly unlimited amount of data available. For example, a user may use a search engine to perform particular searches which may result in a search result list containing thousands, or in some cases millions, of results. The results point to endpoints where the underlying data can be obtained. Thus, a user may need to manually sift through many results to find results that are of particular interest.

This can be especially true when the user is attempting to perform some kind of special purpose search. For example, consider a case where a consumer desires to shop for furniture and other decor for a decorating project. The consumer may have particular styles and coordinating considerations when selecting items to purchase. However, using traditional searching techniques the user may have difficulty identifying items meeting the particular styles and/or coordinating considerations.

For example, if a user were to use a search engine to find items by searching for the items with modifiers and/or descriptions of the items, then the search engine results may exclude items that have not been described or tagged with appropriate descriptive terms. For example, consider a case where a user searches for an Art Deco couch. If the user uses the search terms “Art Deco couch”, only results will be returned where couches are described as being Art Deco in the results themselves, or in some tag associated with the results. Information on couches that are indeed Art Deco, but that are not described as such, will not be returned in the search results. If the user chooses to expand their search by simply searching for couches, then a vast number of search results will be returned requiring the user to sift through the various results to attempt to manually identify couches that are in the Art Deco style. Thus, current search engine user interfaces are difficult to use for specialized searches in that the current interfaces are not able to concisely display search results that are most relevant to the user. Search engines are prone to over include search results or under include search results resulting in the user being unable to access many useful and valuable search results.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that includes acts for applying AI models to a search using a search engine for a user. The method includes receiving user search input at a search engine user interface. The method further includes using the search input with the search engine to obtain first search results. The method further includes applying one or more AI models to the first search results to obtain additional search data. The method further includes searching the additional search data to identify additional search results. The method further includes using the additional search results, identifying a subset of second search results from the first search results while filtering out other search results from the first search results. The method further includes providing at least a portion of the second search results to the user in the user interface while preventing the other search results that were filtered from being displayed in the user interface, such that a user at the user interface has the second search results returned as results to the user search input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a search engine which includes the ability to skin a user interface for the search engine with AI models;

FIG. 2 illustrates a user interface with elements for selecting UI skins;

FIG. 3 illustrates applying AI models to data to create skinned results;

FIG. 4 illustrates applying AI models in series to data to create skinned results;

FIG. 5 illustrates using AI models to create AI models; and

FIG. 6 illustrates a method of skinning a search engine user interface using AI models.

### DETAILED DESCRIPTION

Embodiments illustrated herein are generally directed to a search engine and accompanying user interface that allows a user to “skin” the user interface with artificial intelligence (AI) models.

Note that the AI models illustrated herein are generally augmentation AI models. An augmentation AI model takes as input certain data, and in particular, human consumable data. An augmentation AI model produces data that augments the input data according to a predetermined augmentation goal of the augmentation AI model. That is, the augmentation AI model attempts to produce a certain type augmentation data (as defined by the goal of the AI model) that is related to the input data, usually by providing additional data about individual pieces of input data or groups of pieces of data, where, at least a portion of that additional data was not previously included in the input data, but can be interpreted, rearranged, inferred, deduced, and/or speculated from the input data.

In some embodiments, the augmentation data is produced by aggregating aspects of several of the individual pieces of data in the input data to identify significant classifiable aspects, and then using those classifiable aspects to generate augmentation data for individual pieces of data and/or specific groups of individual pieces of data.

Certain semantics are preserved based on the goal of the AI model. These semantics can be used to search the generated augmentation data to identify augmentation data results, that can be used to identify data in the input data that correlates to the results from the search of the augmentation data.

As used herein, skinning is the process of applying AI models to produce augmentation data and additional automated searches of the augmentation data to a search engine presenting the user interface which causes searches input into the user interface to be affected by the AI models and additional searches to produce search results that are derived from application of the AI models and additional searches without the user needing to directly select or apply the AI models and searches. A skin is a discrete enumeration of AI models and searches that can be applied to a user interface. In some embodiments, the skin may be an executable package including specific AI model logic and search logic. While a user may select a skin, and that skin may have associated AI models and searches, the user will not be able to directly select the AI models and searches, but rather will be able to select a predefined skin.

For example, as illustrated above a user could skin a user interface for a search engine where the skin is an Art Deco skin. In one particular embodiment, this would cause a style analysis AI model, which may be a deep learning model configured to perform natural language processing, image recognition, etc., to identify styles of input data, to be applied to search results received as a result of a user performing the search on the search engine. Applying the AI model for style analysis would analyze the results themselves to identify various styles. For example, the model may analyze images, text, related webpages, or other information as determined by the model to identify the various styles of items included in the results.

Thus, applying an AI model generates additional data about the results. This additional data can be filtered and semantically indexed for additional searching. In particular, an AI model is a model of a particular type and/or sub-type as defined by the goal of the AI model. The additional data generated by applying an AI model is semantically consistent with the goal of the AI model and is indexed where index keys (i.e., the terms and/or concepts to be searched in the index) are semantically indexed such that the index keys are directly related to the index type and/or sub-type. As the goal of the AI model in this particular example is style recognition, the additional data is semantically indexed for style recognition to allow the additional data to be searched for that purpose. In the running example where the user interface is skinned for Art Deco, an additional search will be performed automatically on the newly index data to identify results that, according to be applied AI model, have Art Deco features and characteristics. In this way, other results can be filtered out such that the only results returned to the user are results related to Art Deco furniture.

Thus, for example, a user performs the search for couches using a browser skinned for Art Deco. The search results returned to the user would be Art Deco couches, including results where the couches are not defined as being Art Deco by some previously indexed indicator, such as a textual indicator, included in the index on which the original search was performed. Rather the results would be returned as a result of being identified as being Art Deco by AI style analysis of images or other information, that is later indexed after AI analysis. That is, the Art Deco couches are identified using information that was not originally indexed in the original index for which the general search for couches was performed. Rather, the Art Deco characteristics are identified from searching additional data generated by applying AI models to the original search results. The AI models analyze style to generate data that can search for Art Deco. The skinned user interface and/or search engine will filter out, or remove, search results that do not meet the skinning criteria. For example, results from the original search performed will have any results that do not include Art Deco elements, as identified by the style data produced from applying the AI model, filtered out and removed such that those results are not presented to the user in the user interface.

As discussed previously, augmentation AI models may be used with embodiments of the invention illustrated herein. Augmentation AI models produce additional data that augments input data as discussed above. The following illustrates a number of examples of augmentation AI models. Note that these different types of augmentation models may have some overlap and/or may be used together to accomplish some goal.

One type of augmentation AI model is classification models. Classification models have the goal of classifying data in input data. For example, a classification model could classify data as representing an animal, a person, a color, a style, or virtually any other classification.

Another type of augmentation AI model is detection models. Detection model have the goal of detecting certain characteristics in data. For example, an image recognition model may have a goal of detecting humans in images.

Another type of augmentation AI model is a scene recognition models. Scene recognition models have a goal of detecting specific instances in data. For example, while a detection model may detect a human generally, a scene recognition model may have a goal to detect a specific human.

Another type of augmentation AI model is localization models. Localization models have a goal of detecting details regarding time and space. For example, a localization model may have a goal of identifying a specific location or time that is relevant to data. For example, a localization model may be able to use features in a photograph to determine (within some probability and/or range) where and when the photograph was taken.

Another type of augmentation AI model is similarity/dissimilarity models. Similarity/dissimilarity models have the goal of identifying similarities and/or differences in different pieces of data. For example, a dissimilarity model may have a goal of determining when a particular individual is missing in a photograph, from among a set of photographs.

Another type of augmentation AI model is associative models. Associative models have the goal of identifying when different pieces of data are related. For example, an associative AI model may have the goal of determining what items typically occur together. Such a model could be used to identify when an item is missing.

Another type of augmentation AI model is prediction models. Prediction models have the goal of identifying data that might exist. For example, a prediction model may have a goal of determining what is likely to occur next in time based on a scene in a still photograph. Alternatively or additionally, a prediction model could have the goal of predicting what is behind an object in a still photograph.

Another type of augmentation AI model is summary models. Summary models have the goal of summarizing information from different pieces of data.

Another type of augmentation AI model is transformative models. Transformative models have the goal of changing data according to some predetermined characteristic. For example, a particular transformative model may have the goal of changing an image to a Van Gogh style painting, where Van Gogh style is the characteristic.

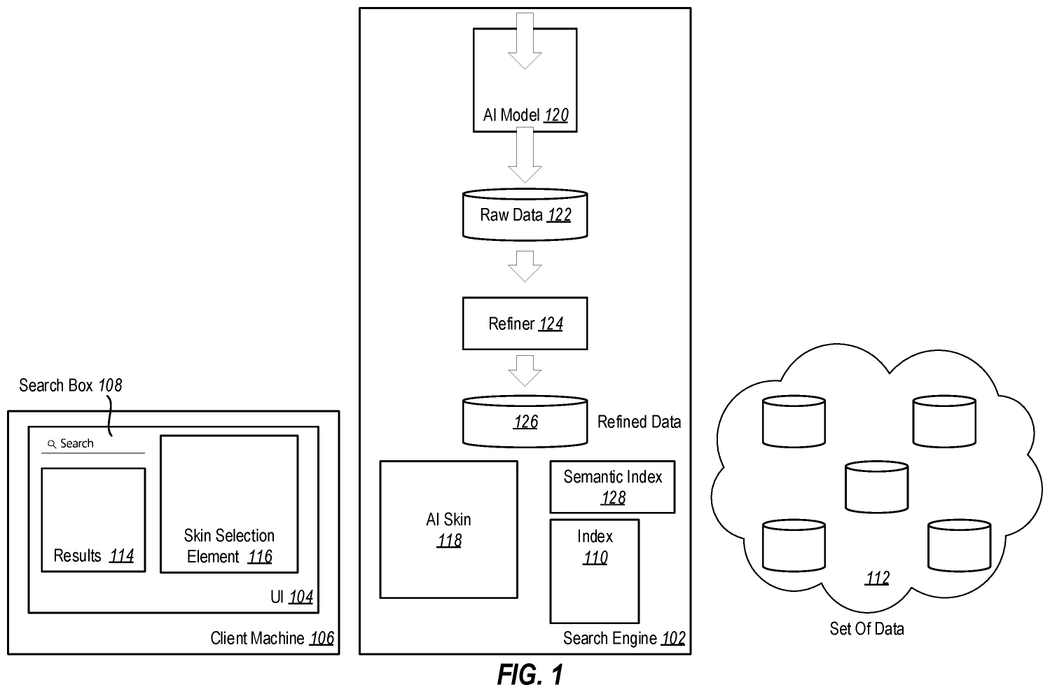

Referring now to FIG. 1 an example embodiment is illustrated. The embodiment illustrated in FIG. 1 shows a search engine 102. The search engine 102 includes computer hardware and software configured to perform searches on behalf of a client using a user interface 104. In particular, the user interface 104 is generally caused to be displayed by the search engine 102 at a client machine 106. Typically, the client machine 106 is at a remote location as compared to the search engine 102. Nonetheless, the search engine 102 renders the user interface 104 at the client machine 106 using various communications and algorithmic actions. A user at the client machine 106 can enter into a search box 108 various search terms. The search terms are provided to the search engine 102. The search engine 102 uses an index 110 to match search terms, operators (such as AND, XOR, OR, etc.), and/or filters (such as time filters, location filters, etc.) entered into the search box 108 to entries in the index 110.

The index 110 stores a correlation of index entries to endpoints storing data. In particular, the index 110 indexes a set of data 112. The set of data 112 may include a number of different data stores and data sets stored in many different locations. For example, many consumer-based search engines use an index which indexes data from a variety of sources and stored at data stores around the world. Thus, the set of data 112 can be nearly unlimited in its scope. The index 110 stores various keywords, or other information, correlated to endpoints where data is stored in the set of data 112. The index 110 will return results to the user interface 104 identifying the endpoints were a user can obtain the data relevant to the search terms entered into the search box 108. Often, the results include portions, or all, of the data from the endpoints.

At the user interface 104, the user can select various links provided by the index 110 to navigate to a data source endpoint having data of interest. In some embodiments, the search results themselves may be the relevant results without need for navigating to a different data source. In some such embodiments, search results will not link to other data sources, but rather, are the relevant data. In alternative embodiments, the search results are the relevant data, but may nonetheless include links to related data or a data source where the relevant data can be found.

The user interface 104 may be skinned with one or more AI models. For example, FIG. 1 illustrates a skin selection element 116 where a user can select a particular skin for the user interface 104. The skin 118 is implemented on the search engine 102 using hardware and software at the search engine 102. The skin 118 selects AI models and performs searches on data generated by the AI models to accomplish the skinning functionality.

Once the skin 118 selects one or more AI models (represented by the AI model 120), the one or more models are instantiated. The AI model 120 takes as input any relevant data. In some embodiments, such data may be data returned from a search using the index 110 on the set of data 112 prior to AI models for skinning being applied.

The AI model 120 operates on the various inputs to create raw data 122. The raw data 122 is passed through a refiner 124 to produce refined data 126. The refined data 126 can be indexed to create a semantic index 128. The semantic index 128 is able to be searched by the search engine 102 under the direction of the skin 118. This allows for additional results to be obtained that can be used to filter, summarize or otherwise modify the results that are displayed in the results interface 114. The returned results displayed in the results interface 114 from searching the semantic index 128 may be data in the refined data 126, or additionally or alternatively may be data from the set of data 112 correlated to the returned results. Thus, using the previous example, the refined data 126 may identify data in the set of data 112, or data in previously returned results, having styles. If a new search is for a particular style, data from the set of data 112 or from previous search results can be identified as having the particular style, such that the data from the set of data 112 or data from previous search results can be returned as results of searching the refined data (which correlates to the set of data 112, search result data, or other data).

In this way, available results are extended by the search engine 102 by identifying AI models that can be implemented to increase the available data (including data relationships) that can be searched by the search engine 102. In some embodiments, the refined data 126 is added to the set of data 112, and the index 110 is expanded to include the semantic index 108 allowing the search engine 102 search across both existing data, as well as data created by applying AI models.

As noted above, when input datasets are operated on by AI models, raw data is produced. The raw data includes a large amount of produced data, much of which will not typically be of interest to a user. Thus, some embodiments may refine the raw data into a refined data structure that can be used by the search engine 102. In some embodiments, a refiner computing entity, such as the refiner 124 discussed above, may be used to perform this functionality. The refinement may involve the refiner 124 truncating, converting, combining, and/or otherwise transforming portions of the AI model output. The refinement may involve the refiner 124 prioritizing portions of the output by perhaps ordering or ranking the output, tagging portions of the AI model output, and so forth. There may be a different refinement specified for each AI model or model type. There may even be a different refinement specified for each model/data combination including an AI model or model type with an associated input dataset or input dataset type. Upon obtaining output data from the AI model, the appropriate refinement may then be applied. The refinement may cause the refiner to bring forth, for instance, what a typical user would find most relevant from a given AI model applied on given data. The actually performed refinement may be augmented or modified by hints specific to an AI model and/or by learned data.

As an illustrative example, certain types of AI models are typically used to try to produce certain types of data. Thus, data that is produced in the raw output data that is not of the type typically evaluated when using a particular AI model may be removed to create refined data.

In some embodiments, the refined data may then be semantically indexed to provide a semantic index (such as semantic index 128) that may then be queried upon by a user. Semantic indexing, and the corresponding retrieval methods used by the search engine 102, are directed to identifying patterns and relationships in data. For example, some embodiments implementing semantic indexing can identify relationships between terms and concepts that are present in otherwise unstructured data. Thus, a semantic indexer may be able to take a set of unstructured data and identify various latent relationships between data elements in the unstructured data. In this way, a semantic indexer can identify expressions of similar concepts even though those expressions may use different language to express the same concepts. This allows data to be indexed semantically as opposed to merely indexing data based on element wise similarity.

A characterization structure might also include a set of one or more operators and/or terms that a query engine may use to query against the semantic index. By providing those operators and/or terms to a query engine, such as the search engine 102, the query engine may extract desired information from the semantic index.

The refinement may also be based on hints associated with that AI model, and/or learned behavior regarding how that AI model is typically used. The obtained results are then refined using the determined refinement. It is then this more relevant refined results that are semantically indexed to generate the semantic index 128.

In some embodiments, feedback is provided to the user is based on new semantics added into a semantic space. In particular, the search engine 102, which is a computer implemented processor that includes data processors and data analyzers, along with a graphical user interface, is able to identify what words are added to a new or existing semantic space. These may have been added as the result of the user adding new data sources to the search engine 102 and/or the result of adding new AI models to a search or search session.

Note that while a specific user interface is illustrated, it should be appreciated that other types of interfaces could be used. For example, in some embodiments, an e-commerce website may be part of the user interface of a search engine.

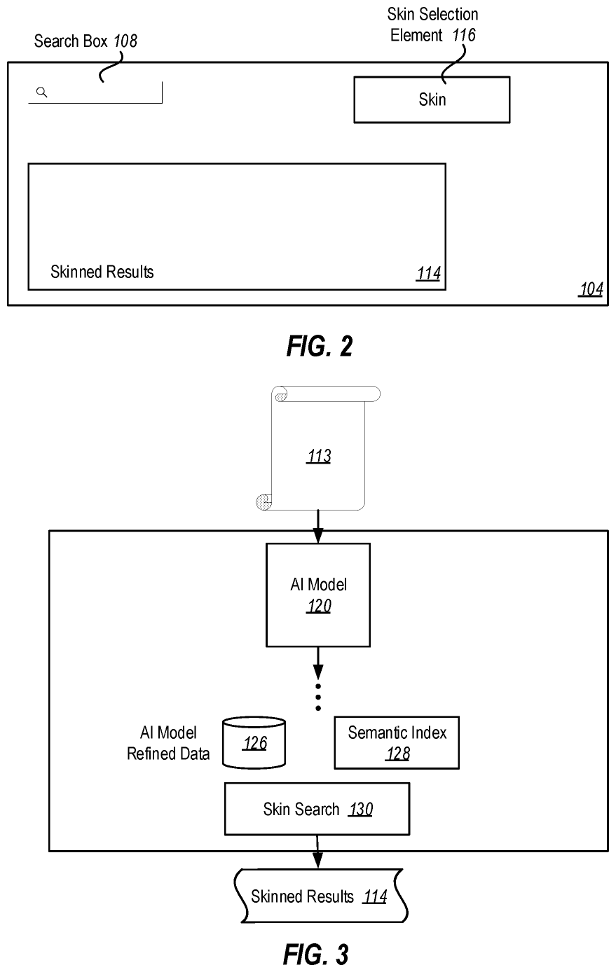

Referring now to FIG. 2, additional details are illustrated. FIG. 2 illustrates a user interface 104. The user interface 104 includes a search box 108. The user interface is able to display skinned results 114. In some embodiments, a skin may be applied without user selection. In particular, a skinned user interface may be presented to a user on a take it or leave it basis, not allowing the user to select the particular skin. However, in some embodiments, the user interface 104 further includes a skin selection element 116. The skin selection element 116 allows a user to select a particular AI model based skin that the user wishes to apply to the user interface 104. In particular, in some embodiments, when the user selects a particular skin from the skin selection element, the user has indirectly selected what AI models will be applied to search results, and what searches will automatically be performed on data produced from applying the AI models. Thus, for example, a user will enter a search, including various terms, operators (such as AND, XOR, OR, etc.), and/or filters (such as time filters, location filters, etc.) The user can then perform various interactions with the user interface 104 to cause the search to be performed. The search will be performed, by searching an index 110 (see FIG. 1) indexing various sets of data as illustrated above. Typically, such a search would return results from the index 110 including pointers to endpoints where the data could be obtained in the set of data 112. However, embodiments herein are modified by providing the results to an AI model 120 (or multiple AI models) determined based on the skin selection element 116.

Reference is now made to FIG. 3 which shows a more detailed example of applying AI models and additional searching using a skinned user interface such as the user interface 104. For the illustrated example, it is assumed that a single AI model is used and a single additional search on data produced by the AI model is performed. FIG. 3 illustrates search results 113. The search results are obtained from a search of the index 110. In some embodiments, the search results 113 may include the data obtained from the set of data 112 from the various endpoints where the data can be obtained. Thus, the results 113 do not necessarily just include links to the data, but may also include the underlying data. In some embodiments, a limited number of results may be included in the search results for analysis by AI models and additional searching. Returning once again to FIG. 3, search results are provided to AI model 120. As described previously, the AI model 120 will produce additional data from the search results 114. For example, such additional data may include information such as style information for search results. In particular, the AI model 120 (along with other elements as described previously) is used to create refined AI data 126 and the semantic index 128. A skin search 130 is then performed, as directed by the skin 118 shown in FIG. 1, on the AI model refined data 126 using the semantic index 128. The skin search 130 is not directly entered by the user, but rather is performed automatically by search engine 102 as a result of the user previously selecting a skin 118 in the skin selection element 116 (or automatically selected for the user). In particular, the skin search 130 performed by the skin 118 searching the semantic index 128 to identify AI model refined data. In particular, the skin search searches for analysis data created by analyzing search results 113. For example, the skin search 130 can attempt to identify analyses having certain criteria. These analyses having the certain criteria will be identified in the refined data 126. Once these analyses have been identified, a link can be made back to the original search results 113 to identify search results in the search results 113 that meet the criteria identified by searching the AI model refined data 126. That is, the AI model refined data 126 includes the results of applying the AI model 120 to the search results 113. Thus, by identifying analysis that meet certain criteria, certain search results from the search results 113 can be identified that meet the analysis criteria.

Thus, for example in the running example above, if the search results 113 include a general search on the index 110 for couches, then the AI model 120 may be configured to analyze the search results to identify various styles in the search results 113. Those styles may be identified by text included in the search results 113, image analysis included in the search results 113, and/or other analyses that may be performed on the search results 114. Refined data 126 is then created regarding the analyses. For example, the refined data may include a correlation of styles to search results. The semantic index 128 indexes the AI model refined data 126. Note that in the example illustrated, the semantic index 128 will include several different styles not simply the Art Deco style in the example above. The skin search 130 will search the semantic index 128 to find entries for Art Deco. The results obtained from the skin search 130 can identify results in the AI model refined data 126, which can then use the correlation stored therein to identify Art Deco couches in the results 113. Those results can then be returned in the skinned results 114 in FIGS. 1 and 2 to display the skinned results to the user in the user interface 104.

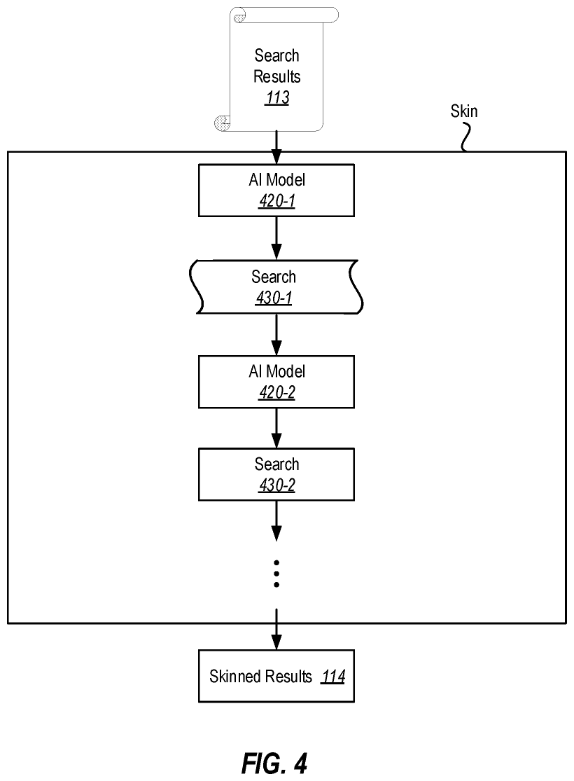

FIG. 4 illustrates an example where embodiments may be implemented by chaining a number of different AI models and additional searches together. For example, FIG. 4 illustrates search results 113 are provided to various AI models and searching mechanisms provided by a skin, such as the skin 118 (see FIG. 1). In this example, the search results 113 first have the AI model 420-1 applied, which produces various additional data as described above. The additional data can be searched by search 430-1, which produces additional results which can be input to another AI model 430-2. This produces additional data that can be searched by the search 420-2. This process can continue until appropriate skinned results 114 are produced and provided to the user in the user interface such as the user interface 104 illustrated in FIG. 1.

Note that in an alternative example, several different AI models may be applied to search results, such as search results 113, before performing any skin searches on the data produced by applying AI models to data. Thus, embodiments can be implemented where one or more different AI models can be used in concert either linearly (applying AI models to data and feeding the results of the AI models into other AI models) or in parallel (applying different AI models to the same data and aggregating the results from the different AI models).

Note that skins may be produced in a number of different ways. For example, in some embodiments, expert searchers may select various AI models and the additional searches that can be applied to a user interface to skin the user interface. Thus, for example, expert searchers may perform various experiments to fine-tune the types of results that are obtained by using various combinations of AI models in searches to create skins that can be applied as executable packages executable by a search engine when selected by a user for use.

In some embodiments, other AI models may be used to create and select the AI models used in the skinning process. For example, in some embodiments, an AI model may be a learning model configured to learn from searches performed by a user. For example, consider a case where a user wishes to apply a model for a particular person. For example, a user may wish to skin their user interface to a particular celebrity or particular public figure. In some embodiments, the skin could be created by using an AI model to monitor searches and search results that are of particular interest to the celebrity or public figure. In particular, the celebrity or public figure could consent to have their searches monitored by an AI model. The AI model monitoring the celebrity or public figure could then produce other AI models that are configured to transform searches by other users, either by modifying the searches in the first instance and/or by analyzing and modifying results from the user's search in the first instance, to allow the user to obtain search results that would be similar to those obtained by the celebrity or public figure if the celebrity or public figure were searching for items being searched by the user. This allows a user to experience search experience similar to a search experience of a celebrity or other well-known public figure.

AI models could be created based on an analyzation AI model analysis of certain data having one or more common features. The analyzation AI model may analyze the data over a number of different parameters. For example, the analyzation AI model may analyze the data over a particular time. Alternatively or additionally, the AI model may analyze the data over particular subclasses of the data. Alternatively or additionally, the analyzation AI model may analyze the data with respect to location or geography. Alternatively or additionally, the analyzation AI model may analyze the data with respect to characteristics of a particular commercial brand. Other parameters may be alternatively or additionally used. The results of the analyzation AI model may be used to create a model for skinning a user interface of a search engine.

In one example, a style analysis AI model may be applied to some category of data known to have a common feature. This would allow characteristics detected for one class of items to be used when searching for a different class of items. For example, a particular brand of automobiles may be analyzed by a style AI model. For example, style features of automobiles produced by the automobile manufacturer could be analyzed to create by an additional AI model that could be used applied to generic search results to identify similar styling. Thus, for example, the user could do a search for couches that had similar styling as a particular automobile brand. As illustrated above, the styling of the automobiles could be analyzed over a particular period of time. Thus, for example, automobiles manufactured between the model years 2005 and 2015 could be analyzed by the style AI model to create a new AI model and/or additional skin searches that could be applied as part of, or in conjunction with, a skin to a user interface.

Illustrating further, certain automobile manufacturers may have different styles depending on the country of sale. Thus, the style AI model could analyze automobiles for a particular country to identify a common style for the manufacturer and country that could be used to create an additional AI model that could be applied to other searches in a skinned user interface.

As yet another example, the style AI model may analyze a subclass. For example, in the running example, an AI model may analyze a subclass such as pickup trucks or other subclasses, to identify style characteristics for use in creating an additional AI model and/or additional searches that could be used to skin user interfaces for a search engine.

Thus, for example, in general AI models may be used to identify certain characteristics of one class of data that could be used to create an AI model where the created AI model could then be used and applied over searches at a search engine generally (i.e., to any appropriate class of data) to produce skinned results using the additional AI model.

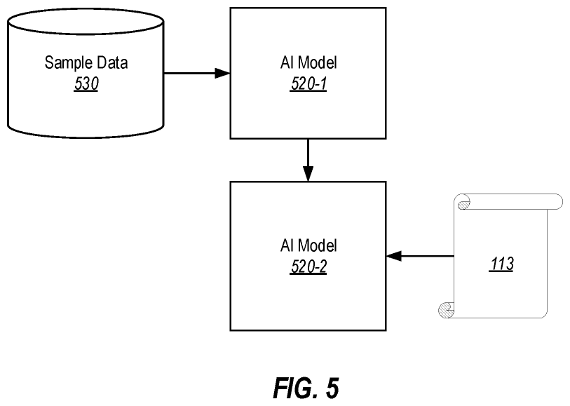

Thus, for example, FIG. 5 illustrates an example where sample data 530 is analyzed by an AI model 520-1. This AI model 520-1 produces a different AI model 520-2 based on analysis of the sample data 530. This additional AI model 520-2 can be applied as part of applying a skin to a user interface for a search engine such that search results 113 produced by the search engine 102 can be have the AI model 520-2 applied to them as illustrated above in a fashion to how AI model 120 is applied to search results.

Embodiments illustrated herein include a number of distinct advantages over previous systems. In particular, some embodiments allow users to have control over what AI models are applied to search sessions through skin selecting. Alternatively, or additionally, embodiments implement a new user interface where specialized results are made available in a more efficient fashion by identifying the results that are relevant to the skin, while excluding other non-relevant results.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

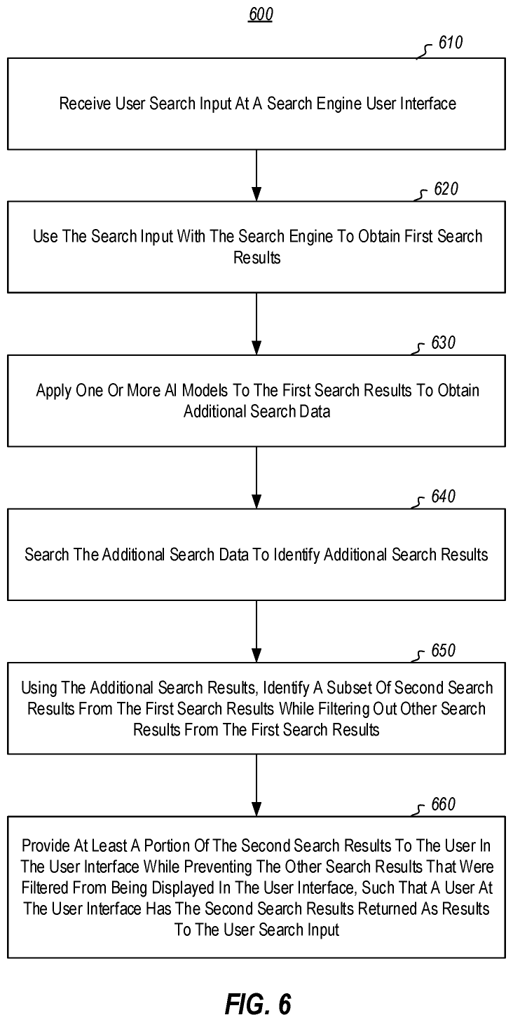

Referring now to FIG. 6, a method 600 is illustrated. The method includes acts for applying AI models to a search using a search engine for a user. The method includes receiving user search input at a search engine user interface (act 610). For example, as illustrated in FIG. 1, a user may input search terms, operators, and/or filters in the search box 108.

The method further includes using the search input with the search engine to obtain first search results (act 620). For example, as illustrated in FIG. 1, the search engine may be used to obtain the search results 113 illustrated in FIG. 3.

The method further includes applying one or more AI models to the first search results to obtain additional search data (act 630). For example, as illustrated in FIG. 1, the refined data 126 may be obtained using the AI model 120.

The method further includes searching the additional search data to identify additional search results (act 640). For example, as illustrated in FIG. 3, the skin search 130 may be performed to obtain additional search results.

The method further includes using the additional search results, identifying a subset of second search results from the first search results while filtering out other search results from the first search results (act 650). For example, the skinned results 114 may be obtained using the additional search results.

The method further includes providing at least a portion of the second search results to the user in the user interface while preventing the other search results that were filtered from being displayed in the user interface, such that a user at the user interface has the second search results returned as results to the user search input (act 660). For example, as illustrated in FIG. 1, the skinned results 114 can be displayed in the user interface 104.

The method 600 may further includes receiving user input selecting a user interface skin defining what AI models and additional searches are applied to the first search results at the search engine user interface. For example, a user may use the skin selection element to apply the AI skin 118 to the user interface 104.

The method 600 may be practiced where applying the one or more AI models comprises identifying styles exhibited by the first search results, and wherein searching the additional search data comprises identifying results that have a particular predetermined style.

The method 600 may be practiced where applying the one or more AI models comprises applying one or more models created using other AI models used to monitor search activities of another user.

The method 600 may be practiced where applying the one or more AI models comprises applying one or more models, created using one or more other AI models analyzing one class of items, to a different class of items.

The method 600 may be practiced where applying the one or more AI models comprises applying one or more models configured to analyze data over at least one of a particular time period.

The method 600 may be practiced where applying the one or more AI models comprises applying one or more models configured to analyze data over a particular geography.

The method 600 may be practiced where applying the one or more AI models comprises applying one or more models configured to analyze data with a particular brand.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable media having stored thereon instructions that are executable by the one or more processors to configure the computer system to apply AI models to a search using a search engine for a user, including instructions that are executable to configure the computer system to perform at least the following:
receive user search input at a search engine user interface;
use the search input with the search engine to obtain first search results;
apply one or more data augmentation AI models to the first search results to obtain additional search data, wherein each of the AI models in the one or more AI models is configured to generate the additional search data to augment search data to which the AI model is applied according to a predetermined augmentation goal, and wherein the additional search data is search data that is semantically consistent with the augmentation goals of the one or more AI models;
search the additional search data to identify additional search results;
using the additional search results, identify a subset of second search results from the first search results while filtering out other search results from the first search results; and
provide at least a portion of the second search results to the user in the user interface while preventing the other search results that were filtered from being displayed in the user interface, such that a user at the user interface has the second search results returned as results to the user search input.

2. The computer system of claim 1, wherein one or more computer-readable media further have stored thereon instructions that are executable by the one or more processors to configure the computer system to receive user input selecting a user interface skin defining what AI models and additional searches are applied to the first search results at the search engine user interface.

3. The computer system of claim 1, wherein applying the one or more AI models comprises identifying styles exhibited by the first search results, and wherein searching the additional search data comprises identifying results that have a particular predetermined style.

4. The computer system of claim 1, wherein applying the one or more AI models comprises applying one or more models created using other AI models used to monitor search activities of another user.

5. The computer system of claim 1, wherein applying the one or more AI models comprises applying one or more models, created using one or more other AI models analyzing one class of items, to a different class of items.

6. The computer system of claim 1, wherein applying the one or more AI models comprises applying one or more models configured to analyze data over a particular time period.

7. The computer system of claim 1, wherein applying the one or more AI models comprises applying one or more models configured to analyze data over a particular geography.

8. The computer system of claim 1, wherein applying the one or more AI models comprises applying one or more models configured to analyze data with a particular brand.

9. A method of applying AI models to a search using a search engine for a user, the method comprising:
receiving user search input at a search engine user interface;
using the search input with the search engine to obtain first search results;
applying one or more data augmentation AI models to the first search results to obtain additional search data, wherein each of the AI models in the one or more AI models is configured to generate the additional search data to augment search data to which the AI model is applied according to a predetermined augmentation goal, and wherein the additional search data is search data that is semantically consistent with the augmentation goals of the one or more AI models;
searching the additional search data to identify additional search results;
using the additional search results, identifying a subset of second search results from the first search results while filtering out other search results from the first search results; and
providing at least a portion of the second search results to the user in the user interface while preventing the other search results that were filtered from being displayed in the user interface, such that a user at the user interface has the second search results returned as results to the user search input.

10. The method of claim 9, further comprising, receiving user input selecting a user interface skin defining what AI models and additional searches are applied to the first search results at the search engine user interface.

11. The method of claim 9, wherein applying the one or more AI models comprises identifying styles exhibited by the first search results, and wherein searching the additional search data comprises identifying results that have a particular predetermined style.

12. The method of claim 9, wherein applying the one or more AI models comprises applying one or more models created using other AI models used to monitor search activities of another user.

13. The method of claim 9, wherein applying the one or more AI models comprises applying one or more models, created using one or more other AI models analyzing one class of items, to a different class of items.

14. The method of claim 9, wherein applying the one or more AI models comprises applying one or more models configured to analyze data over a particular time period.

15. The method of claim 9, wherein applying the one or more AI models comprises applying one or more models configured to analyze data over a particular geography.

16. The method of claim 9, wherein applying the one or more AI models comprises applying one or more models configured to analyze data with a particular brand.

17. A search engine comprising:
one or more processors;
one or more computer-readable media having stored thereon instructions that are executable by the one or more processors;
wherein the one instructions include instructions that are executable to configure the computer system to present a user interface to a user, including:
present a skin selection element to a user;
receive user input at the skin selection element selecting a user interface skin defining what AI models and additional searches are applied to search results to produce additional search data;
receive user search input at a search engine user interface;
wherein the search engine is configured to use the search input with the search engine to obtain first search results;
a skin, wherein the skin is configured to:
apply one or more data augmentation AI models, wherein each of the AI models in the one or more AI models is configured to generate the additional search data to augment search data to which the AI model is applied according to a predetermined augmentation goal, and wherein the additional search data is search data that is semantically consistent with the augmentation goals of the one or more AI models;
search the additional search data to identify additional search results;
using the additional search results, identify a subset of second search results from the first search results while filtering out other search results from the first search results; and
wherein the user interface is configured to provide at least a portion of the second search results to the user in the user interface while preventing the other search results that were filtered from being displayed in the user interface, such that a user at the user interface has the second search results returned as results to the user search input.

18. The search engine of claim 17, wherein applying the one or more AI models comprises identifying styles exhibited by the first search results, and wherein searching the additional search data comprises identifying results that have a particular predetermined style.

19. The search engine of claim 17, wherein applying the one or more AI models comprises applying one or more models created using other AI models used to monitor search activities of another user.

20. The search engine of claim 17, wherein applying the one or more AI models comprises applying one or more models configured to analyze data with a particular brand.
